(19) United States
(12) Patent Application Publication
(10) Pub. No.: US 2011/0203218 A1
(43) Pub. Date: Aug. 25, 2011

(54) SPRAY ON BARRIER SYSTEMS AND METHODS OF MAKING SAME

(76) Inventors: Jerry SOLOV, Acworth, GA (US); Andrew Knapp, Acworth, GA (US)

(21) Appl. No.: 13/032,904

(22) Filed: Feb. 23, 2011

Related U.S. Application Data
(60) Provisional application No. 61/307,290, filed on Feb. 23, 2010.

(51) Int. Cl. E04B 7/00; E04B 1/682; B22F 1/00; B05C 11/00; B05D 1/34

(52) U.S. Cl. 52/745.06; 524/1; 118/606; 427/426

(57) ABSTRACT

A reinforced, variable strength, fluid applied, waterproofing and/or air barrier membrane system assembled in the field is described. The membrane can comprise two major components: a carrier fluid and reinforcement elements. The carrier fluid can comprise a polymer fluid, and the reinforcing elements can comprise a reinforcing fiber composition. The polymer fluid can comprise one or more of a variety of catalyzed or atmospherically cured resin-based or non-resin based fluid vehicles. The reinforcing fibers can comprise one or more of a variety of chopped-length synthetic or natural fibers of suitable tensile strength and elongation. The polymer fluid and the reinforcing fibers can be combined and sprayed onto many surfaces that need to be waterproofed, weatherproofed, or sequestered.

### CROSS REFERENCE TO RELATED APPLICATIONS

This application claims benefit under 35 USC §119(e) of U.S. Provisional Patent Application Ser. No. 61/307,290 filed 23 Feb. 2010, the entire contents of which are hereby incorporated fully herein by reference.

### BACKGROUND OF THE INVENTION

1. Field of the Invention

The present invention relates generally to barrier coatings, and more specifically to an improved spray-on coating that can be used in a variety of applications as an air and/or liquid barrier for, among other things, new roofs, roof restoration, industrial and medical isolation, air and microbial isolation and sequestration.

2. Description of the Related Art

Conventional roofing for commercial and industrial buildings can include a roof deck, a layer of insulation, a waterproof membrane, and an exterior surface. Many commercial buildings have flat roofs upon which a commercial roofer commonly applies roll roofing in large single sheets. Asphalt is generally applied to the surface of the roof and the roll roofing is then applied on top of the asphalt. Alternatively, the roll roofing may have a layer of asphalt on one surface that is heated to apply the roll roofing to the roof.

Exposure to the elements causes these roofs, and particularly the applied asphalt, to dry out and become cracked over time. This can cause the roll roofing to buckle and separate from the roof decking, causing failure. The failure of the roll roofing, the asphalt, or both can cause water penetration. Water penetration, in turn, can cause structural damage, rot, and insect problems. In addition, indoor air quality can be negatively affected as the result of mold, mildew, and other microorganisms.

Failed roof systems are sometimes repaired by hot mopping the roof with asphalt. This involves heating asphalt, in melters, to a minimum of 350° F., transporting it to the roof, and mopping some, or all, of the roof surface with string mops dipped in the hot asphalt. The temperatures involved present an obvious burning or scalding risk to workers, both when transporting the hot asphalt up to the roof and when mopping the asphalt onto the roof. In addition, with asphalt melters there is a risk of spontaneous combustion and/or explosion due to the high temperatures involved and the possibility of overheating. In many cases, particularly for cold-applied asphalt roofing, the asphalt is thinned with volatile solvents to improve its fluidity. Solvent-bearing asphalt adhesives thus also create the possibility of fire, spontaneous ignition, contamination, and/or explosion.

Other techniques used to effect roof repairs involve using heavy rolls of woven or non-woven sheet or mat material. The material is applied to the roof structure with an adhesive, which is generally asphalt based. The adhesive is typically applied to the existing roof structure, the mat is placed on the roof and smoothed, and then additional adhesive is applied over the top of the mat. This multi-step process requires additional labor and application time, increasing costs.

In some instances, such as when significant portions of the roof have failed or delaminated, it may be necessary to replace the entire existing roofing system. This involves significant expense in stripping the existing roofing system and decking, replacing the decking, preparing the substrate, and installing the new roofing system. In addition, as landfills near capacity and EPA regulations tighten, the disposal of construction materials (e.g., the old decking and roofing materials) can represent a significant expense during the reroofing process.

Conventional methods for creating an air barrier are similarly labor intensive. Buildings are often wrapped in building wrap (e.g., Tyvek®). This requires the building to be wrapped in a cloth like material, which is attached to the building in an overlapping fashion using a suitable fastener, such as staples. Where the wrap covers an opening, such as a window or a door for example, the wrap must be trimmed and fastened accordingly. The process is time consuming and the result, i.e., how well sealed the structure is, relies heavily on the skill and care used during installation.

What is needed, therefore, is a product and process for creating an air and/or liquid proof membrane with improved elasticity, durability, and tensile strength. The product and process should be easy to apply and cost effective. It is to such a product and process that embodiments of the present invention are primarily directed.

### SUMMARY OF THE INVENTION

Briefly described, in a preferred form, embodiments of the present invention can comprise a product, system, and method for providing a waterproofing and/or weatherproofing membrane on a variety of surfaces (the “system”). Specifically, the system can provide a unitary, flexible, waterproof membrane comprising a carrier fluid and reinforcing elements. The system, which can comprise a combination of a carrier fluid and reinforcing elements, can be sprayed onto a variety of surfaces. This can be useful, for example and not limitation, for new and existing roof structures, basement and below grade waterproofing, prevention of air infiltration, and for waterproofing other products such as planters or artificial ponds.

The carrier fluid can comprise a liquid polymer. The liquid polymer can be any one or more of a variety of resin-based or non-resin based fluid vehicles. The liquid polymer can cure atmospherically or can cure by catalyzation. A catalyzed liquid polymer can be used to control pot life and/or adjust for variations in application conditions (e.g., temperature and humidity) when desirable. The carrier fluid can comprise, for example and not limitation, acrylic polymers, epoxies, polyurethanes, rubber modifiers and silicones. In a preferred embodiment, the liquid polymer can be a one-component water-based polymer such as, for example and not limitation, an acrylic polymer.

The carrier fluid can be reinforced with reinforcement elements. The reinforcement elements can comprise non-woven, twisted, or individual fibers, filaments, or strands introduced into the carrier fluid. The fibers can be a single type of fiber or can be a mixture of two or more types of fibers and can be chosen, among other things, based on strength requirements and cost constraints. The fibers can include, but are not limited to, nylon, polyester, carbon fiber, fiberglass, or Aramid® fibers.

The system can be spray applied by hand or using an adjustable spray gun. In a preferred embodiment, the carrier fluid and reinforcing elements can be combined as a concurrent spray-on operation by the gun. In some embodiments, the components can be mixed inside the gun. In other components, the components can be mixed externally to the gun by, for example, the nozzle of the gun. In some embodiments, the gun can be supplied with chopped reinforcing fibers. In other embodiments, the gun can be supplied with a reinforcing strand that is cut inside the gun to provide a chopped length reinforcement fiber.

The thickness and strength of the system can be varied. The thickness of the system can be varied, for example and not limitation, by varying application speed, application pressure, or the number of coats applied. The strength of the system can be varied, for example and not limitation, by varying the polymer fluid or composition thereof, increasing or decreasing the concentration of reinforcing fibers, or using different reinforcing fibers, different combinations of reinforcing fibers, and/or different combinations of reinforcing fibers and polymer fluids.

The foregoing and other objects, features, aspects, and advantages of the present invention will become more apparent from the following detailed description of the present invention.

### BRIEF DESCRIPTION OF THE FIGURES

FIG. 1a depicts embodiments of the present invention in a single layer installed on a new roof system, in accordance with some embodiments of the present invention.

FIG. 1b depicts embodiments of the present invention in multiple layers installed on a new roof system, in accordance with some embodiments of the present invention.

FIG. 2a is a flowchart related to a method of building up a roofing system including rigid insulation, in accordance with some embodiments of the present invention.

FIG. 2b is a flowchart related to a method of building up a roofing system with no insulation, in accordance with some embodiments of the present invention.

FIG. 3 depicts embodiments of the present invention in a single layer installed on an existing roof system, in accordance with some embodiments of the present invention.

FIG. 4a depicts embodiments of the present invention installed in a paving environment, in accordance with some embodiments of the present invention.

FIG. 4b is a detailed view of the paving system shown in FIG. 4a, in accordance with some embodiments of the present invention.

FIG. 5a depicts embodiments of the present invention installed on the front of a standard partition type wall system, in accordance with some embodiments of the present invention.

FIG. 5b depicts embodiments of the present invention installed on the rear of a standard partition type wall system, in accordance with some embodiments of the present invention.

FIG. 6 depicts a spool-type applicator gun, in accordance with some embodiments of the present invention.

FIG. 7 depicts an applicator gun with an external hopper, in accordance with some embodiments of the present invention.

FIG. 8 depicts an applicator gun with a fiber supply hose, in accordance with some embodiments of the present invention.

### DETAILED DESCRIPTION OF THE INVENTION

To facilitate an understanding of the principles and features of the various embodiments of the invention, various illustrative embodiments are explained below. Although preferred embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the preferred embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a system containing “a” component is intended to include other components in addition to the one named.

Also, in describing the preferred embodiments, terminology will be resorted to for the sake of clarity. It is intended that each term contemplates its broadest meaning as understood by those skilled in the art and includes all technical equivalents, which operate in a similar manner to accomplish a similar purpose. Ranges may be expressed herein as from “about” or “approximately” one particular value and/or to “about” or “approximately” another particular value. When such a range is expressed, other exemplary embodiments include from the one particular value and/or to the other particular value.

The words “comprising,” “containing,” or “including” conveys that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

Embodiments of the present invention relate to a sprayed on air and/or waterproofing membrane. The system preferably comprises a spray of liquid polymer reinforced with chopped fibers. The polymer can be sprayed using a gun, and the chopped fibers can be introduced concurrently to produce a reinforced waterproofing layer.

The liquid polymer can be one or more of a variety of resin-based and non-resin based fluid vehicles. The liquid polymer can cure atmospherically or can cure by catalyzation. A catalyzed liquid polymer can be used to control pot life and/or adjust for variations in application conditions (e.g. temperature and humidity) when desirable. The liquid polymer can be one or a combination of fluid elastomer vehicles, including but not limited to, acrylic; polyurethane; polymeric, non-asphaltic thermoplastic; silicone; epoxies, butyl rubber; polyurea; or hybrid vehicles that combine two or more of these components. In a preferred embodiment, the liquid polymer can be a one-component water-based polymer such as, for example and not limitation, an acrylic polymer.

The liquid polymer can be reinforced with non-woven, twisted, or individual fibers, filaments, or strands introduced into the liquid polymer. The fibers can be a single type of fiber or can be a mixture of two or more types of fibers. The fibers can be, for example and not limitation, graphite, fiberglass, polyester, polypropylene, nylon, Kevlar®, carbon fiber, Aramid®, rayon, jute, or a combination of two or more of these fibers. The reinforcing fibers can comprise a single material, e.g., nylon, or a mixed material, e.g., Aramid with carbon fiber and fiberglass.

As presented, the current system does away with the conventional need to apply carrier fluid to a sheet or mat reinforcement product. Embodiments of the present invention can comprise a polymer carrier fluid and one or more reinforcing fibers to create a sprayable, unitary roofing material. In this configuration, application time is reduced and uniform results can be achieved with a minimum of training and skill.

In some embodiments, the liquid polymer and the reinforcing fibers can be mixed in a hopper and then applied with a spray gun as a mixture. In other embodiments, the liquid polymer and reinforcing fibers can be mixed in the spray gun. In still other embodiments, the liquid polymer and reinforcing fibers can be mixed externally to the spray gun (e.g., by a nozzle on the gun). In yet other embodiments, the spray gun can comprise a liquid polymer supply line and a hopper containing chopped fiber. In this configuration, the spray gun can spray the liquid polymer and pull chopped strands out of the hopper at a metered rate. In a preferred embodiment, an application gun can be supplied liquid polymer and a continuous reinforcing strand (e.g., a roll of reinforcing strand can be provided on the gun). In this configuration, the reinforcing strand can be cut inside the gun into a uniform length or into a mixed length chopped state, mixed with the liquid polymer, and then sprayed onto the application surface. The liquid polymer and the chopped reinforcing fibers can be mixed internally or externally to the gun to provide a uniform surface.

In some embodiments, the system can further comprise an acceleration subsystem and/or a catalyzing subsystem. For example, the spray gun can be supplied with compressed air as an acceleration subsystem to accelerate the liquid polymer and reinforcing strands toward the application surface. The liquid polymer can be mixed with chopped reinforcing fibers internally or externally to the gun and ejected from a fixed or adjustable nozzle or orifice. In other embodiments, the liquid polymer can be supplied to the gun at relatively high pressure where it can be mixed with reinforcing fibers and ejected from a fixed or adjustable nozzle.

In some embodiments, the gun may have an airless design, similar to commercial house painting equipment, e.g., the liquid polymer can be supplied to the gun at high pressure using an airless pump. In still other embodiments, a catalyst for the liquid polymer may be supplied to the liquid polymer prior to entering the gun or the catalyst can be added by the gun itself. In some embodiments, the gun can provide an adjustment to control the rate of catalyst that is fed into the liquid polymer. This can enable the amount of catalyst per unit of polymer fluid to be adjusted for varying application conditions (e.g., temperature and humidity).

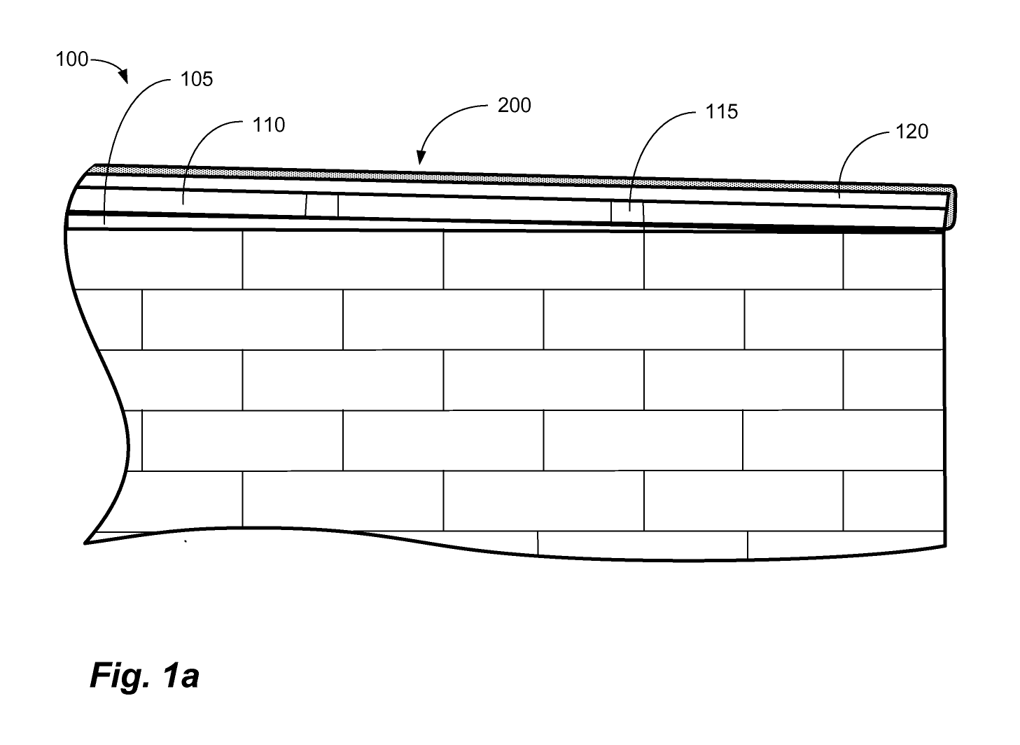

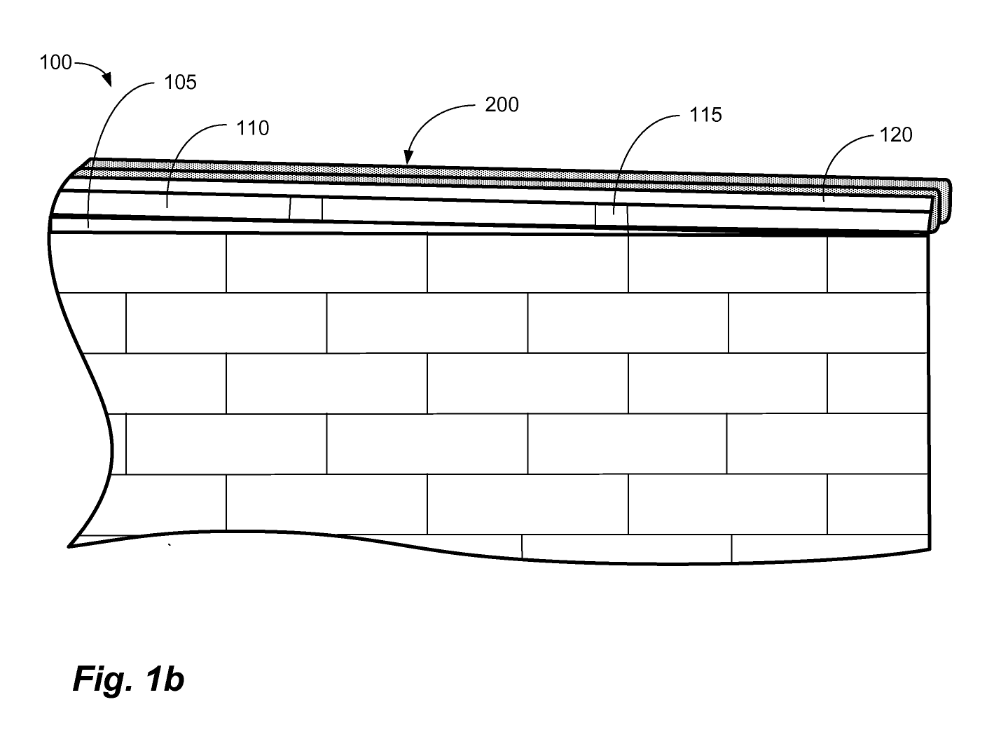

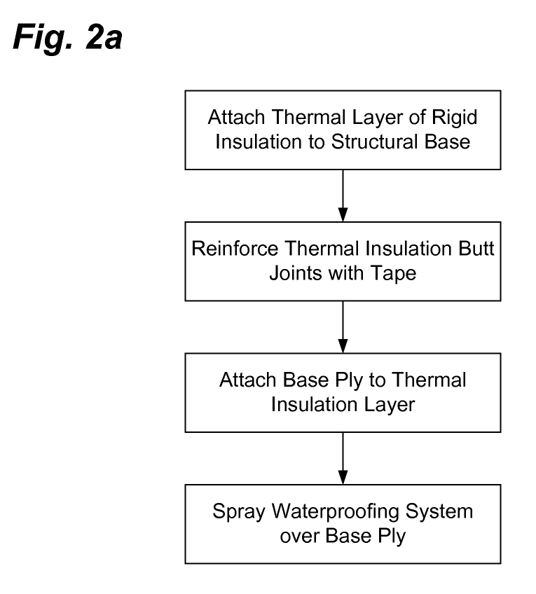

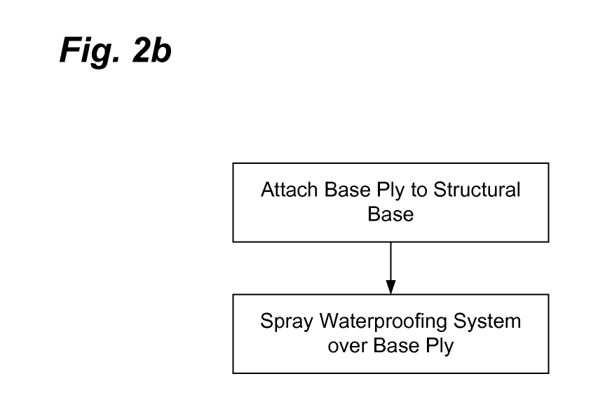

As shown in FIGS. 1a-2b, embodiments of the present invention can be used in conjunction with a new roof system 100 on a structural base 105. In some embodiments, the new roof system 100 may utilize a thermal layer 110. In some embodiments, the thermal layer can comprise, for example and not limitation, fiberglass bat, spray foam insulation, or cellulose insulation. In a preferred embodiment, rigid insulation panels 110 can be secured to the structural base 105 using, for example and not limitation, construction adhesive. In some embodiments, the rigid insulation panels 110 can also be taped 115 along the edges where the panels 110 butt together to seal the seams. A reinforcing base ply 120 of, for example and not limitation, plywood, oriented strand board, gypsum board, or hybrid gypsum sheathing can be adhered to the thermal layer 110 using, construction adhesive, collared nails, or screws, or other suitable means. The system 200 can then be sprayed on the base ply 120 to form a reinforced, variable strength, fluid applied unitary layer that can be composed and assembled in the field. The spray application means the membrane 200 can be applied quickly and can conform to irregular surfaces and fill in voids and gaps to create a unitary weather, air, and water barrier.

As shown in FIG. 2b, in other applications, such as in temperate climates or in non-climate controlled structures, the thermal layer 110 can be omitted and the reinforcing base ply 120 can be adhered directly to the structural base 105. The system 200 can then be sprayed on the base ply 120 to form a reinforced, variable strength, fluid applied layer composed and assembled in the field.

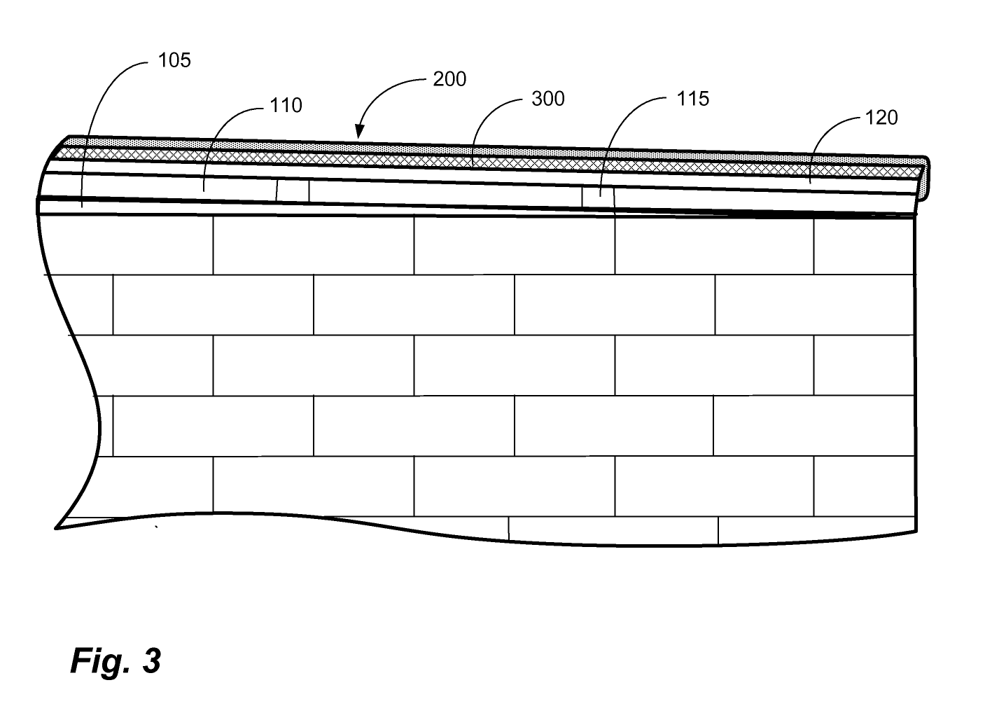

In other embodiments, as shown in FIG. 3, the system 200 can be used for establishing a new, sacrificial layer on top of an existing, but worn roofing system 300. The new system 200 can restore the worn system 300 to like new condition and provide a new product warranty. The color of the new sacrificial layer can be chosen for its thermal properties. In some climates, such as in the southwest U.S. for example, the sacrificial layer can be white to achieve a higher Solar Reflective Index (SRI). This can enable the roofing system 200 to have reduced thermal gain and reduce related cooling costs. In other climates, such as in the northeast U.S. for example, a dark color can be used to increase solar absorption (i.e., lower the SRI) to increase solar gain and reduce heating costs. The subsequent reduction in cooling or heating demand, as applicable, can decrease long-term energy costs and can partially or completely offset the cost of repair.

For repair, loose debris can be removed from the existing roof system 300 and the existing roof system 300 can be cleaned. The surface can be prepared and, in some cases depending on the existing roof system 300, may need to be primed or otherwise treated to promote proper adhesion. The system 200 can then be sprayed over the existing roof system 300 creating a seamless, flexible roof membrane. The system 200 can be sprayed to fill cracks and crevices and restore a substantially smooth roof surface. The system 200 can be cleaned and recoated indefinitely. In this manner, the system 200 can be re-warranted and sustained for the life of the structure. The system 200 can be applied over many types of existing roof systems 300, including but not limited to, asphalt built-up, modified bitumen, EPDM rubber, thermoplastic olefin, Hypalon®, PVC, Evaloy®, rigid foam, asphalt or fiberglass shingles, and metal roofs.

The strength of the waterproof/weatherproof membrane system 200 can be varied in several ways. For example, the strength of the system can be changed by varying the thickness of the application. This can be controlled, for example and not limitation, by a flow setting on the application gun, by application or modulation of air pressure or fluid pressure, by application rate, or by number of coats applied. In some embodiments, as shown in FIG. 1b, multiple coats can be applied to build up a membrane of the desired thickness. In some embodiments, the polymer fluid used may require coats to “flash” or cure prior to the application of additional layers. In other embodiments, the polymer fluid can contain a solvent that partially reactivates or “melts” existing layers to promote adhesion. This can enable roofs previously coated with the system 200 to be recoated easily during subsequent repair or replacement. In a preferred embodiment, the system 200 should reach a thickness of at least 40 dry mils.

The strength of the membrane can also be adjusted by varying the amount and type of reinforcing fibers used. The amount of fiber used per unit of polymer fluid can be varied, for example, by a setting on the application gun. In general, including more reinforcing fiber (up to a point) produces a stronger, more rigid membrane. In some embodiments, where the substrate to be sealed has increased movement and/or flexion, or where the surface is highly irregular, it can be desirable to include less reinforcing fiber, smaller (e.g., more finely chopped) fibers, or to utilize a different class of fiber or fibers to promote flexibility and increase flow of the system 200 to conform to surface irregularities and fill cracks and crevices.

The strength of the membrane can also be varied by changing the composition of both the reinforcing fibers and the polymer fluid. Some polymer fluids, such as polyester resin for example, cure to form a substantially glass-like material with minimal flexibility. Other polymer fluids, on the other hand, such as butyl rubber, acrylic, polyurethane, SEBS, or silicone cure to form a substantially flexible, rubber-like membrane. The type of fiber used can also affect strength and/or pliability of the system. For example, Kevlar, the trade name for a para-aramid synthetic fiber, has a significantly higher tensile strength than fiberglass. When coupled with the appropriate polymer fluid, therefore, Kevlar can produce a stronger membrane, albeit at a higher cost.

The strength and flexibility of the waterproof/weatherproof membrane system 200 can be varied in response to the type of structure on which the system is being used. If the system 200 is being applied to a roof on a steel or concrete building, for example, a substantially rigid system can be used. If the system 200 is being applied to a less rigid structure, one with significant movement, or one subject to extreme weather (e.g., hurricane force winds in Florida) a less rigid system can be used. The less rigid formulations of the system 200 can be useful for applications such as, for example and not limitation, houseboats, RVs, boats, commercial trailers, inflatable covers for athletic facilities, entrance canopies, and buildings subjected to high winds, which can have both less rigid structures and increased movement due to induced flexion.

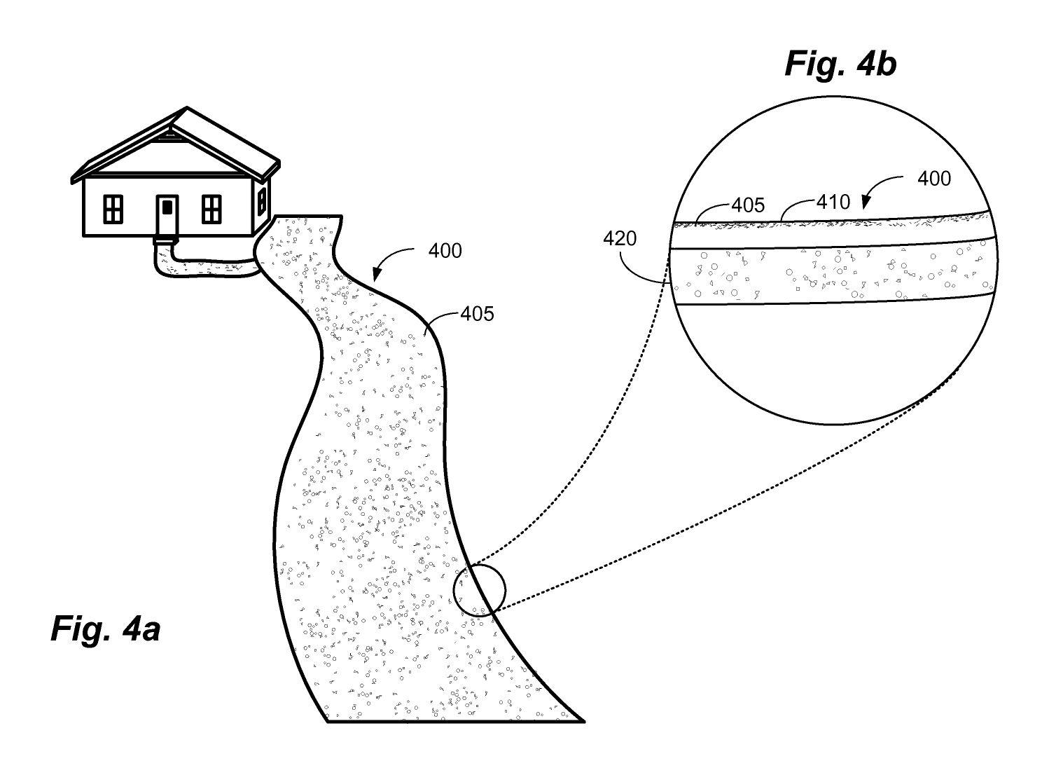

In some embodiments, as shown in FIG. 4, the system 400 can be used to create or repair, for example and not limitation, driveways, walkways, sidewalks, car ports, garage floors (collectively, surfaces 420). The system 400 can be applied over existing asphalt or concrete surfaces 420, for example, for repair or improvement of these areas. In some embodiments, a mineral, sand, or other granulated finish (or, “aggregate”) 405 can be applied over the system 400 to provide a slip resistant surface. In some embodiments, the aggregate 405 can be added by the application gun along with, or instead of, the reinforcing fibers. In other embodiments, the aggregate 405 can be added to the surface 410 of the system 400 after application. In this configuration, the aggregate 405 is preferably added while the system is still “wet” to promote adhesion. The layer of aggregate 405 can improve the abrasion resistance of the system 400 and provide additional traction.

In this configuration, the system 400 can be used to repair, seal, and stabilize, for example and not limitation, cracked or damaged driveways, walkways, carports, and parking lots. A flexible version of the system 400 can be used, for example, as a covering for playgrounds or other activity areas, where a resilient, water resistant membrane is desired. The system 400 can be used in other applications where a flexible, strong waterproofing layer is needed, such as for example and not limitation, a base for vegetative roof systems, a below grade waterproofing membrane, or a liner for planters.

In other embodiments, the system can be used to create an air barrier, applied to the envelope of a commercial or residential structure. In this configuration, the system can meet or exceed the function and thermal effectiveness of fiberglass insulation. Batt fiberglass insulation, for example, does not deliver an air barrier to the structure. In addition, the effectiveness of fiberglass insulation varies greatly based on installation. For example, fiberglass batt often performs below its rated R-value due to improper installation including among other things, improper compression during installation.

In weatherproofing a structure, the infiltration of cold air, drawn into a structure via pressures created by internal convection and other sources, is the most crucial factor to be reduced, controlled, and/or eliminated. Embodiments of the present invention can provide a fully adhered, unitary air barrier, for an entire structure minimizing or eliminating such air infiltration. Such a structure, with only the air barrier provided by the system (i.e., with no insulation) just using the stud or block wall air space can deliver significantly the same benefit as an insulation with fiberglass, or other, insulation and no air barrier.

Embodiments of the present invention can provide an air barrier in a variety of applications. Applications such as commercial structures, medical facilities, laboratories, clean rooms, production facilities, paint and powder coating booths, and chemical booths, among others, have a need for a practical, cost effective reinforced air barrier system that can be applied quickly and with consistent results.

Conventionally, isolation in these applications can only be accomplished by extensive manipulation of construction materials, extensive handwork, specially designed, interlocking, gasketed components, or other costly means and methods. For example, air barrier systems, such a Tyvek®, are predominantly composed of large sheets that are mechanically attached to the exterior of a structure. At openings and penetrations in the structural envelope, such as windows and doors, the field sheets must be adapted and terminated. This is often accomplished with the use of self-adhering sub-components that are tediously custom cut to fit the application.

The overall effectiveness of this type of sheet system, therefore, depends on the skill and patience of the installer and the amount of production time allotted for tying-in each opening, limit, or penetration. In practice, mechanically attached, loose-sheet air barrier systems are not as effective as other options, though their components may be somewhat less costly. Self-adhesive sheets are available, but are more expensive and also must be custom cut and fit to all structural limits, openings, and penetrations.

Water-based, asphaltic, spray-on emulsions are also available to create air barriers. This system is generally sprayed on, but is not reinforced. In addition, asphaltic systems lack appreciable flexibility and thus can fail if the underlying structure shifts or flexes. Cracks in the system can cause air infiltration, defeating the purpose of the system, and resulting in a loss of investment in the installation. Asphaltic systems also contain significant volatile organic chemicals (VOCs) that can pose an occupational danger to installers and ongoing air quality problems in the structure due to off gassing. Where local codes ban using certain carrier fluids, e.g., California, the system 200, 400 can be adapted by selecting an appropriate carrier fluid that is in compliance. The embodiments of system 200, 400 can be configured, and are uniquely adaptable, on a regional basis without sacrificing system quality or performance

Embodiments of the present invention relate to a reinforced and elastomeric system that, in its cured state, can withstand normal conditions of structural movement without failure. No loss of investment or function of the provided air barrier is suffered due to expected structural movement. The system can be installed quickly and requires less skill to install. The combination of spray-on reinforcement in a carrier fluid, both of which are variable components, make it adaptable to many conditions, types of inner and outer wall surfaces, temperatures, humidities, and fire rating requirements.

For example, in the case of a hospital or medical facility, where flame spread and smoke generation are code specified, the system can be adjusted into compliance. The system is easily applied during both retrofit and new construction, facilitating a dramatic change in building dynamics. The chosen carrier fluid can be non-toxic, enabling change in one part of a structure without contaminating the ventilation system in another occupied area. Similarly, biosoluble reinforcing fibers can be chosen to reduce or eliminate issues related to ingestion of the fibers in animals (e.g., respiratory ingestion by people or pets). The fibers are then fully encapsulated in one concurrent operation with the application gun, further reducing ingestion risks.

The system can be used, for example and not limitation, in hospitals and research labs to create containment areas to prevent the spread of bacteria, viruses, and other airborne pathogens. The system can be used in industrial applications to sequester dangerous chemicals, such as for example and not limitation, VOCs. The system can also be used to create “clean rooms” used, for example and not limitation, for research and the assembly of products such as automotive engines, transmissions, and computer products that require especially clean working or assembly environments. The system can be used in facilities for preparation of liquid and solid fuels, or facilities for loading rocket motors, for example, to prevent fuel contact with ignition sources. The system can also be used as an economical sequestration barrier for, for example and not limitation, armament or pesticide production, the inside of wash-down rooms, car washing facilities, and sewage treatment plants,

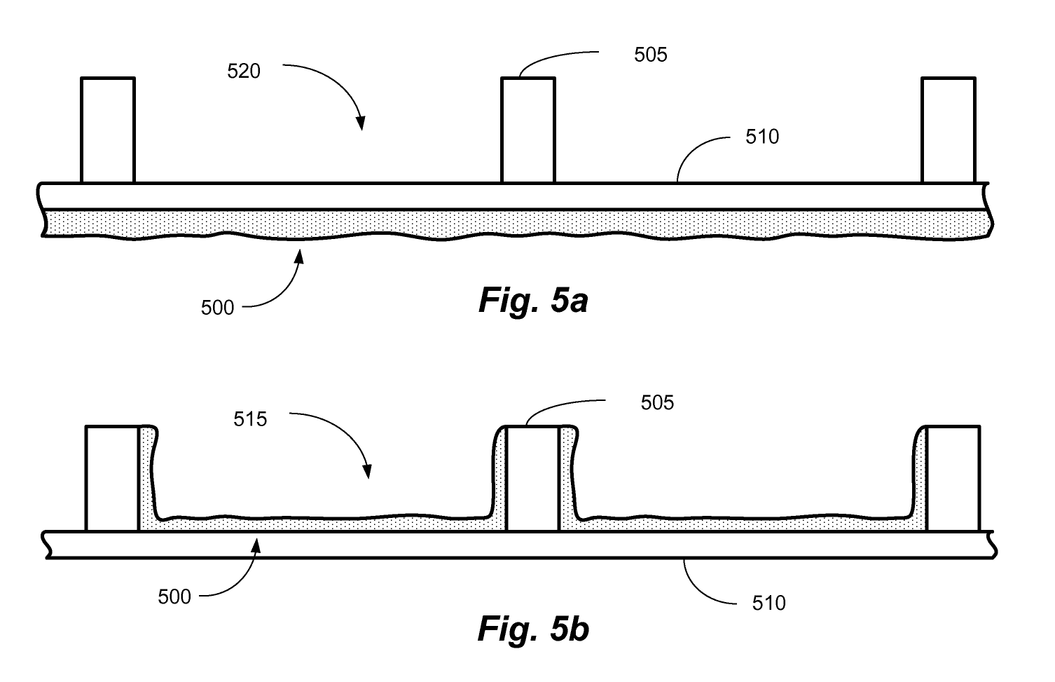

Embodiments of the present invention can also comprise a wall system 500. As shown in FIGS. 5a and 5b, partition walls 520 can be constructed in the customary fashion using, for example and not limitation, wood or metal studs 505 sheathed in drywall 510. The drywall 510 can then be sealed from the front using the system 500 instead of, or in addition to, traditional tape and mud finishing. In an alternative embodiment, as shown in FIG. 5b, the system can be applied in the stud cavities 515 on the rear of the drywall 510 to substantially seal the wall 520 from the back side. The front of the wall 520 can then be finished using a suitable technique, such as a traditional tape and mud technique.

In some embodiments, the system 500 can act as the finish coat for the wall 520. The carrier fluid and/or reinforcing fibers can be colored using standard commercial pigments. In this manner, the system 500 can serve as a functional element and a cost-saving method of finishing the walls 520 and ceilings when compared to the three-step hand worked method generally used for taping, blocking, and finishing wallboards. By varying the carrier fluid, fiber quantity, and/or introducing additives to the system, enhanced fire protection, insulation, or aesthetic properties can be provided, including protection from ignition and flame spread, improved texture, and entrained color. Fire protection, in particular, can be especially useful when storing documents, artifacts, and/or valuables.

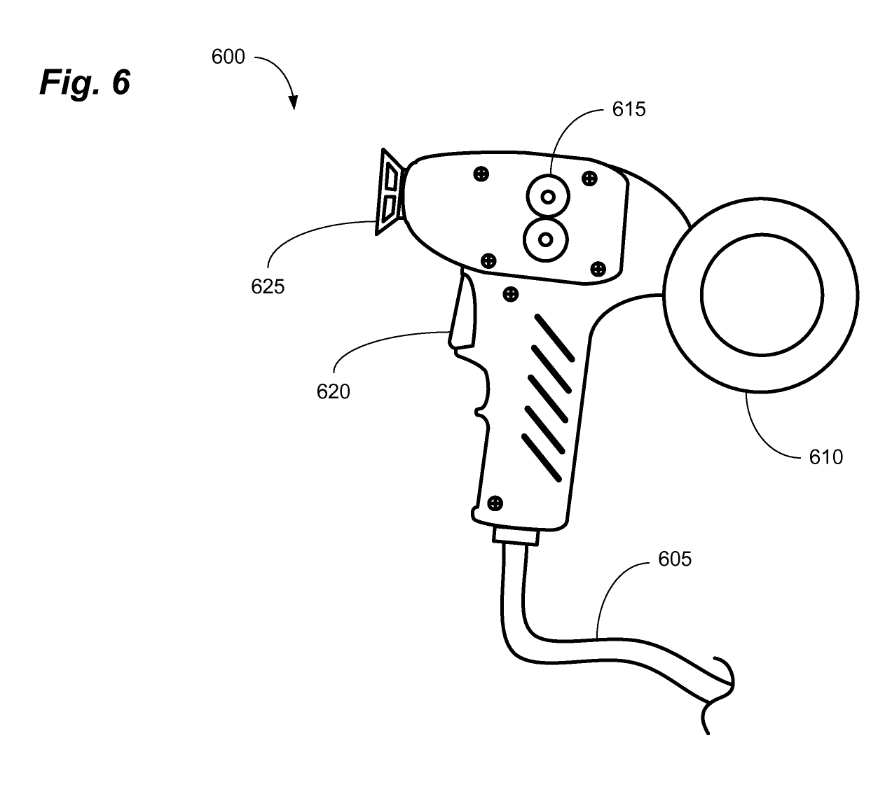

As shown in FIG. 6, the system can further comprise an applicator gun 600. In some embodiments, the applicator gun 600 can comprise a carrier fluid inlet 605, a reinforcing fiber spool 610, a cutter head 615, a trigger 620, and a nozzle 625. Carrier fluid can be supplied to the inlet 605 under pressure. This can be accomplished using, for example and not limitation, an airless pressure pump or an air compressor. The spool 610 can supply a continuous reinforcing fiber (e.g., fiberglass) to a cutter head 615. The cutter head 615 can cut the reinforcing fiber into a plurality of equal or variable length reinforcing fibers. The nozzle 625 can be a fixed or variable orifice or venturi for directing the carrier fluid and the reinforcing fibers onto the surface being coated.

In some embodiments, the carrier fluid and fibers can be mixed in a mixing chamber inside the gun 600. In other embodiments, the carrier fluid and reinforcing fibers can be mixed externally to the gun 600 by, for example, the nozzle 625. In some embodiments, the spool 610 and the cutter head 615 can be powered by an electric or pneumatic motor inside the gun 600. In other embodiments, the spool 610 and cutter head 615 can be powered by hydraulic pressure provided by the pressurized carrier fluid.

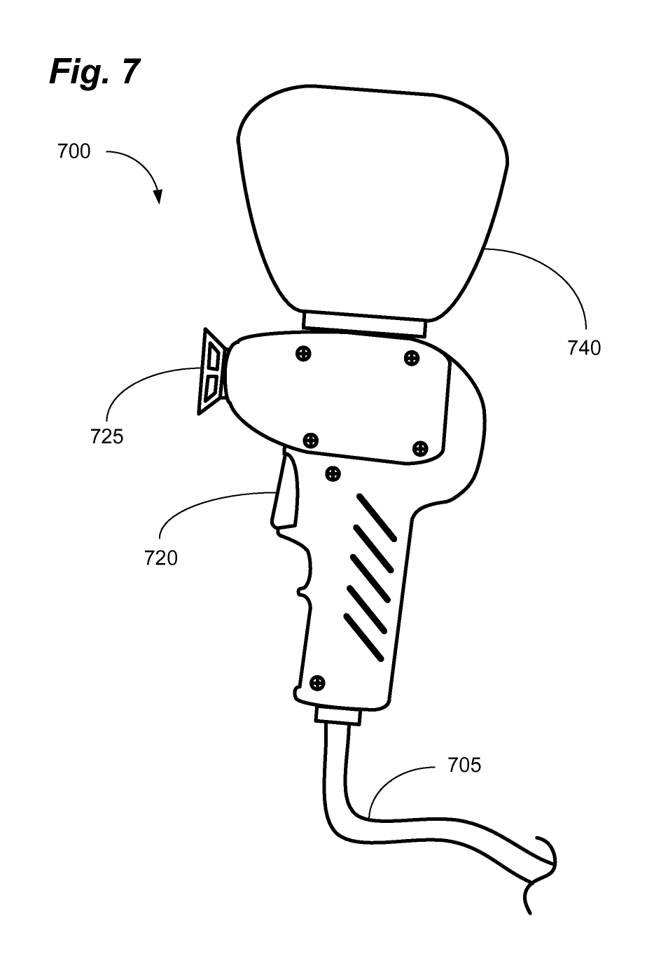

As shown in FIG. 7, embodiments of the present invention can comprise an applicator gun 700 with an external hopper 740. In this configuration, the hopper 740 can contain chopped reinforcing fibers of uniform or mixed lengths. The hopper 740 can provide pre-chopped reinforcing fibers to the gun 700. In some embodiments, the hopper 740 can comprise a valve, or other adjustment means, to control the flow rate of fibers out of the hopper 740. As before, carrier fluid can be supplied under pressure to the gun 700 via the carrier fluid inlet 705. In some embodiments, the carrier fluid and fibers can be mixed in a mixing chamber inside the gun 700. In other embodiments, the carrier fluid and reinforcing fibers can be mixed externally to the gun 700 by, for example, the nozzle 725.

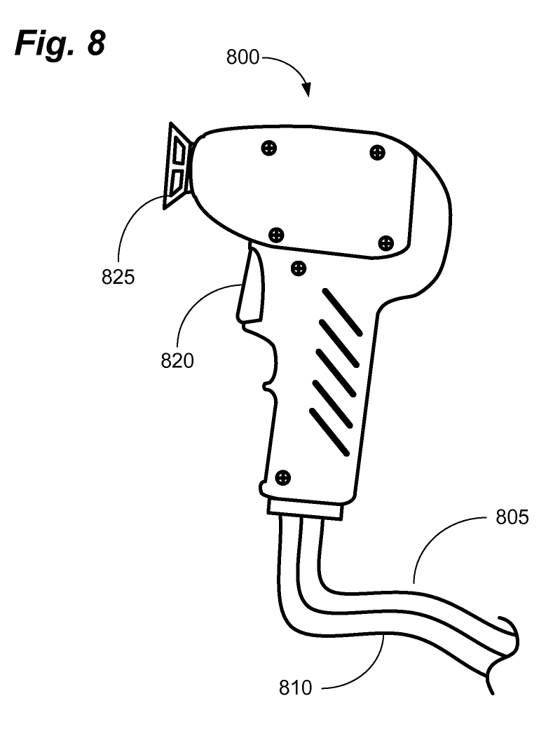

In still other embodiments, as shown in FIG. 8, the applicator gun 800 can be supplied chopped uniform or mixed length reinforcement fibers via a fiber supply hose 810. As before, carrier fluid can be supplied under pressure to a carrier fluid inlet 805. In some embodiments, the carrier fluid and reinforcement fibers can be combined inside the gun 800 in a mixing chamber. In other embodiments, the carrier fluid and reinforcement fibers can be combined outside the gun as they are being applied (e.g., by the action of the nozzle 825).

Regardless of the configuration of the gun 600, 700, 800, in use, the user can press the trigger 620, 720, 820 causing the carrier fluid to flow through the gun and out the nozzle 625, 725, 825. The reinforcing fibers can then be mixed with the carrier fluid, either internally or externally, and directed toward the object surface by the nozzle 625, 725, 825. The nozzle 625, 725, 825 can create an even layer of the fibers and the carrier fluid to accumulate on the surface to the desired thickness. In some embodiments, the layer can be rolled to, for example, remove air bubbles and create a more uniform surface.

The applicator gun 600, 700, 800 can also provide an adjustment means to adjust the ratio of carrier fluid to reinforcing fibers. This can enable the user to, for example, create a particularly thin mix (e.g., a higher ratio of carrier fluid) to fill in surface irregularities or a thicker mix (e.g., a higher ratio of fibers) to meet strength requirements. In other embodiments, the gun 600, 700, 800 can include a catalyst injection system to mix a catalyzer with the carrier fluid. In a preferred embodiment, the catalyst injection system can have a variable flow rate to enable the ratio of catalyzer to carrier fluid to be adjusted. This can enable the ratio of catalyzer to be adjusted to compensate for, for example and not limitation, the carrier fluid used, application thickness, temperature, and humidity.

While several possible embodiments are disclosed above, embodiments of the present invention are not so limited. For instance, while several possible configurations have been disclosed (e.g., a roofing, paving, or wall system), other suitable materials and configurations can be selected without departing from the spirit of embodiments of the invention. Additionally, while several configurations and designs are discussed and illustrated for the applicator gun, other configurations are possible and are contemplated herein. The present invention can be modified to provide a unitary, impenetrable coating for a variety of structures. In addition, the composition and configuration used for various features of embodiments of the present invention can be varied, for example, according to a particular waterproofing, wind proofing, structural, or aesthetic need. Such changes are intended to be embraced within the scope of the invention.

The specific configurations, choice of materials, and the size and shape of various elements can be varied according to particular design specifications or constraints requiring a device, system, or method constructed according to the principles of the invention. For example, while certain exemplary ranges have been provided for thicknesses and locations, other configurations can be used for different sized containers or cargos. Such changes are intended to be embraced within the scope of the invention. The presently disclosed embodiments, therefore, are considered in all respects to be illustrative and not restrictive. The scope of the invention is indicated by the appended claims, rather than the foregoing description, and all changes that come within the meaning and range of equivalents thereof are intended to be embraced therein.

What is claimed is:

1. A system for providing an air or watertight barrier on a surface comprising:
a fiber reinforcing component; and
a liquid elastomer component;
wherein the fiber reinforcing component and the liquid elastomer component are combined during application to form a substantially air or watertight barrier.

2. The system of claim 1, wherein the liquid elastomer component comprises a one-component water-based elastomer.

3. The system of claim 1, further comprising an applicator gun, the applicator gun comprising:
an inlet for receiving the liquid elastomer component under pressure;
a cutter for cutting the fiber reinforcing component into a plurality of reinforcing fibers; and
a nozzle for externally combining the liquid elastomer component and the plurality of reinforcing fibers and for directing the liquid elastomer component and the plurality of reinforcing fibers onto the surface.

4. The system of claim 3, further comprising an adjustment means to enable a ratio of the liquid elastomer component to the plurality of reinforcing fibers to be adjusted.

5. The system of claim 3, further comprising a catalyst injector for introducing a catalyst into the system;
wherein the catalyst injector provides an adjustable injection rate.

6. The system of claim 1, further comprising an applicator gun, the applicator gun comprising:
an inlet for receiving the liquid elastomer component under pressure;
a hopper for storing a chopped fiber reinforcing component; and
a nozzle for externally combining the liquid elastomer component and the chopped fiber reinforcing component and for directing the liquid elastomer component and the chopped fiber reinforcing component onto the surface.

7. The system of claim 6, further comprising a hopper valve for adjusting a flow rate of chopped fiber reinforcing component from the hopper.

8. The system of claim 1, further comprising an applicator gun, the applicator gun comprising:
an inlet for receiving the liquid elastomer component under pressure;
a cutter for cutting the fiber reinforcing component into a plurality of chopped reinforcing fibers;
a mixing chamber for combining the liquid elastomer component from the inlet and the plurality of chopped reinforcing fibers inside the applicator gun; and
a nozzle for directing the liquid elastomer component and the plurality of chopped reinforcing fibers onto the surface.

9. A method for providing an air or watertight membrane on a surface comprising:
supplying a pressurized carrier fluid to an applicator gun;
supplying a plurality of reinforcing fibers to the applicator gun;
combining the plurality of reinforcing fibers and the pressurized carrier fluid at a predetermined ratio;
spraying the combined plurality of reinforcing fibers and the pressurized carrier fluid onto the surface to form a unitary membrane;
wherein the unitary membrane is airtight, watertight, or both.

10. The method of claim 9, further comprising:
supplying a continuous reinforcing fiber to the applicator gun;
chopping the continuous reinforcing fiber into the plurality of reinforcing fibers inside the applicator gun.

11. The method of claim 9, wherein the carrier fluid and the plurality of reinforcing fibers are combined externally to the applicator gun.

12. The method of claim 9, wherein the carrier fluid and the plurality of reinforcing fibers are combined inside the applicator gun.

13. The method of claim 9, wherein the plurality of reinforcing fibers comprise two or more different types of reinforcing fibers.

14. The method of claim 9, further comprising:
rolling the unitary, air or watertight membrane to remove air bubbles and provide a substantially uniform surface.

15. The method of claim 9, further comprising:
embedding an aggregate into a top surface of the unitary, air or watertight membrane to provide a slip resistant surface.

16. A method for providing a roofing system comprising:
affixing a plurality of panels comprising an insulating material to a structural base;
affixing a base ply layer to the plurality of panels to provide a substantially rigid surface;
applying a first sprayable composite membrane to the base ply layer to form a unitary membrane that is waterproof, airtight, or both;
wherein the unitary membrane comprises:
a fiber reinforcing component; and
a liquid elastomer component; and
wherein the fiber reinforcing component and the liquid elastomer component are combined during application.

17. The method of claim 16, further comprising:
applying a primer to the base ply layer to promote adhesion of the unitary membrane.

18. The method of claim 16, further comprising:
taping each joint where each of the plurality of panels intersects with each adjacent panel to seal the joint from water infiltration, air infiltration, or both.

19. The method of claim 16, further comprising:
applying an aggregate layer to a top surface of the unitary membrane to provide a slip resistant surface.

20. The method of claim 16, further comprising:
applying a second sprayable composite membrane to the first sprayable composite membrane to increase the thickness, strength, or both of the unitary membrane.
